(19) United States
(12) Patent Application Publication
(10) Pub. No.: US 2011/0173976 A1
(43) Pub. Date: Jul. 21, 2011

(54) ENERGY GENERATING SYSTEM USING A PLURALITY OF WATERWHEELS

(76) Inventors: Sean Brian Meadon, Midrand (ZA); Anne-Marie Meadon, Midrand (ZA)

(21) Appl. No.: 13/062,444

(22) PCT Filed: Sep. 5, 2008
(86) PCT No.: PCT/IB2008/002303

§ 371 Date: Mar. 4, 2011

(30) Foreign Application Priority Data
Sep. 6, 2007 (ZA) 2007/07660

(51) Int. Cl. F03B 7/00; F03B 13/08

(52) U.S. Cl. 60/639; 290/54

(57) ABSTRACT

An energy generating system is provided, comprising a primary waterwheel for receiving water from a head penstock or upper pumping setup, the primary waterwheel comprising a plurality of radial arms rotatable about a primary axis, the radial arms terminating in water scoops for accommodating the water from the head penstock or upper pumping setup, the primary waterwheel defining head height. The system further comprises at least one additional waterwheel located within the head height of the primary waterwheel, the additional waterwheel also comprising a plurality of radial arms rotatable about an axis, the radial arms terminating in water scoops for accommodating either excess water from the head penstock or upper pumping setup or water that has spilled out of the water scoops of the primary waterwheel. In an example embodiment, the primary waterwheel and the at least one additional waterwheel are vertically orientated. In an example embodiment, the at least one additional waterwheel is smaller than the primary waterwheel.

### FIELD OF THE INVENTION

This invention relates to an energy generating system using a plurality of waterwheels, and in particular, to the improvement of the generation of hydro-electric power by means of an integrated configuration of a plurality of waterwheels. This invention also refers to improvements in the general shape and construction of individual waterwheels with a view to increasing their efficiency in their generation of electrical energy from flowing water.

### BACKGROUND OF THE INVENTION

A waterwheel is a hydropower machine which extracts power from the flow of water. The most efficient earliest waterwheels were so-called overshot waterwheels, and these comprised water scoops or buckets for receiving and temporarily holding water flowing over the waterwheel from an elevated head of water, which in turn caused the waterwheel to turn. Other types included undershot and breast waterwheels, but they were far less efficient. Overshot waterwheels have the advantage of not only transferring some of the energy of flowing water directly into its rotation, but also transferring the force due to the weight of water into its rotation as well. These overshot waterwheels however, have a number of design flaws that resulted in vast volumes of water being wasted/spilled, and therefore making them relatively inefficient.

Waterwheels were gradually replaced by turbines as these proved to be more efficient and less costly in building. However, turbines generally need to be installed at the time that a dam wall is being constructed, and their efficiency is primarily a function of their positioning and design criteria. A penstock is typically used to connect the water flow from a head of water to the turbine, with, accordingly the performance of the turbine also being directly a function of the flow of water through the penstock and of the final head of water. Thus, structurally, a turbine-based hydropower system is a once-off design that is very specific to a particular dam's arrangement, which is limiting.

Therefore, in order to make optimal use of the advantages of energy transfer that a waterwheel has, and the advantage of being able to install it after a dam wall has already been completed, the efficiency of using waterwheels in power generation needs to be increased to compete with that of turbines.

It is also recognized that the energy created from a waterwheel is in fact an extension of a simple lever principle, where the weight of water in the wheel multiplied by the length of spoke on the waterwheel provides a rotational energy in the axle of the waterwheel. This is countered by the loss of energy due to friction in various forms as the wheel rotates.

### OBJECT OF THE INVENTION

It is therefore an object of the present invention to provide an energy generating system using a plurality of waterwheels, with the system aiming to improve the efficiency of the waterwheels, whilst also reducing the loss of energy due to friction.

### SUMMARY OF THE INVENTION

According to the invention there is provided an energy generating system comprising:
a primary waterwheel for receiving water from a head penstock, the primary waterwheel comprising a plurality of radial arms rotatable about a primary axis, the radial arms terminating in water scoops for accommodating the water from the head penstock, the primary waterwheel defining head height;
at least one additional waterwheel located within the head height of the primary waterwheel, the additional waterwheel also comprising a plurality of radial arms rotatable about an axis, the radial arms terminating in water scoops for accommodating either excess water from the head penstock or water that has spilled out of the water scoops of the primary waterwheel.

In an example embodiment, the primary waterwheel and the at least one additional waterwheel are vertically orientated.

In an example embodiment, the at least one additional waterwheel is smaller than the primary waterwheel.

In an example embodiment, the at least one additional waterwheel comprises a secondary waterwheel for receiving excess water from the head penstock. In an example embodiment, the secondary waterwheel is arranged to convey water back onto the water scoops of the primary waterwheel.

In an example embodiment, the at least one additional waterwheel comprises a tertiary waterwheel for receiving water that has spilled out of the water scoops of the primary waterwheel.

In an example embodiment, the width of the water scoops of the secondary waterwheel is less than the width of the water scoops of the primary waterwheel, which in turn is less than the width of the water scoops of the tertiary waterwheel.

In an example embodiment, the radial arms of each waterwheel are tapered so that the scoop situated at the very ends of the radial arms is widened so as to carry the maximum amount of water as close to the end of the radial arms as possible.

In an example embodiment, the water scoops are connected together at their ends by a weighted outer rim to create a flywheel effect.

In an example embodiment, the water scoops define breather holes along their edges.

In an example embodiment, the waterwheels are attached via their central axes to a gear mechanism which is then in turn connected to an alternator/generator system, each capable of transferring the rotative power of each waterwheel into electrical energy.

In an example embodiment, an upper pumping setup is located in the vicinity of the head penstock so as to provide a consistent flow of water through the head penstock from a dam to which the head penstock is fitted.

In an example embodiment, the waterwheels are fitted with braking means for controlling their rotation.

### BRIEF DESCRIPTION OF THE DRAWINGS

A preferred embodiment of the invention will be described, by way of example only, with reference to the drawings in which:

FIG. 1 is a sectional side elevation of an energy generating system using a plurality of waterwheels, according to an example embodiment of the present invention;

FIG. 2 is a sectional plan view of the system shown in FIG. 1;

FIG. 3 is a detailed view of a portion of a waterwheel spoke and scoop that may be used in the system shown in FIGS. 1 and 2, emphasizing features of the invention for rendering the waterwheel less prone to resistance from stationary air as it rotates; and

FIG. 4 is a sectional side elevation, similar to FIG. 1, but here the expected flow of water is shown, as well as the necessary features to convert the waterwheel of the present invention to a potential pump storage device.

### DESCRIPTION OF PREFERRED EMBODIMENTS

This invention deals with the maximizing of power extracted from falling water, with the preferred embodiment below being described with reference to an overshot waterwheel. However, it is feasible that similar waterwheel configurations can use other types of waterwheels, and these are also included in the scope of this invention.

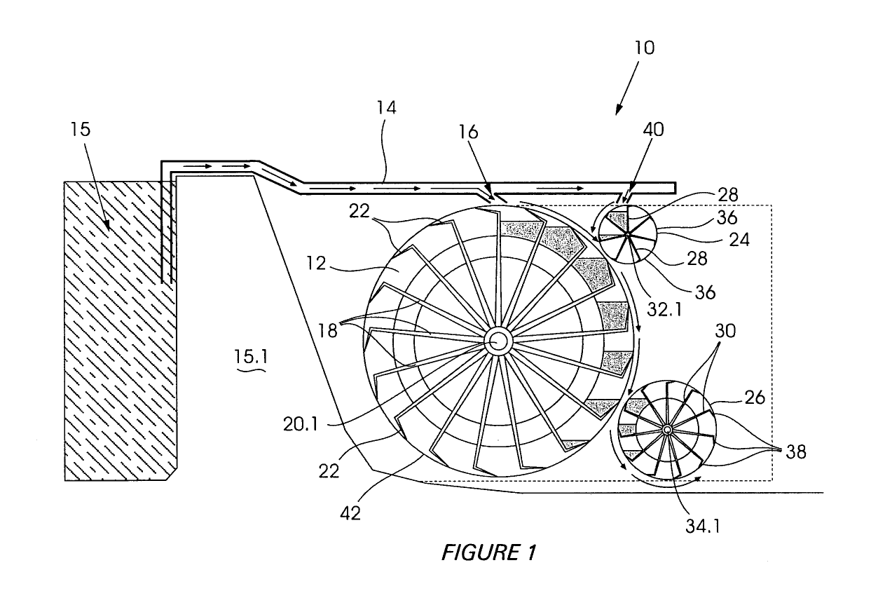

Referring first to FIGS. 1 to 3, an energy generating system 10 is shown comprising a primary waterwheel 12 for receiving water from a head penstock 14 having a first outlet 16 defined therein. The head penstock 14 is arranged to receive water from a dam 15 supported by a dam wall 15.1 in any one of a number of known ways. For example, although not shown, an upper pumping set may be provided to pump water into the penstock 14 for transport to the system 10.

The primary waterwheel 12 comprises a plurality of radial arms 18 rotatable about a primary axis 20, the radial arms 18 terminating in water scoops 22 for accommodating the water from the head penstock 14. The primary waterwheel 12 defines an effective head height, indicated by broken line marked ‘h’.

The system 10 further comprises a pair of waterwheels 24, 26 located within the head height ‘h’ of the primary waterwheel 12. The additional waterwheels 24, 26 typically also comprises a plurality of radial arms 28, 30, respectively, rotatable about axes 32, 34, the radial arms 28, 30 terminating in water scoops 36, 38, respectively, for accommodating either excess water from the head penstock 14 or water that has spilled out of the water scoops 22 of the primary waterwheel 12, as will be described in more detail further on in the specification.

In an example embodiment, the primary waterwheel 12 and the additional waterwheels 24, 26 are vertically orientated.

As best shown in FIG. 1, the additional waterwheels 24, 26 are smaller than the primary waterwheel 12.

In an example embodiment, one of the additional waterwheels 24, 26 comprises a secondary waterwheel 24 for receiving, and therefore being driven by, excess water leaving the head penstock 14 via a second outlet 40 defined therein. As best shown in FIG. 1, the secondary waterwheel 24 may be arranged to convey water back onto the water scoops 22 of the primary waterwheel 12.

Another of the additional waterwheels 24, 26 defines a tertiary waterwheel 26 for receiving, and therefore being driven by, water that has spilled out of the water scoops 22 of the primary waterwheel 12. It can therefore be seen that the provision of the second and tertiary waterwheels 24, 26 aims to maximise the energy available from the falling water.

As indicated above, the two additional waterwheels 24, 26 are contained within the head height ‘h’ of the primary waterwheel 12, and thus their efficiency will be added to that of the main wheel. In this example, the secondary waterwheel 24 is able to place water between 50-70 degrees off the primary waterwheel's top dead centre, thus extending the period that the primary waterwheel 12 can be given water, yet at the same time the secondary waterwheel 24 is also generating additional torque on its own axis. Simultaneously, the tertiary waterwheel 26 is arranged to capture all the falling water from 90-135 degrees off the primary waterwheel's top dead centre.

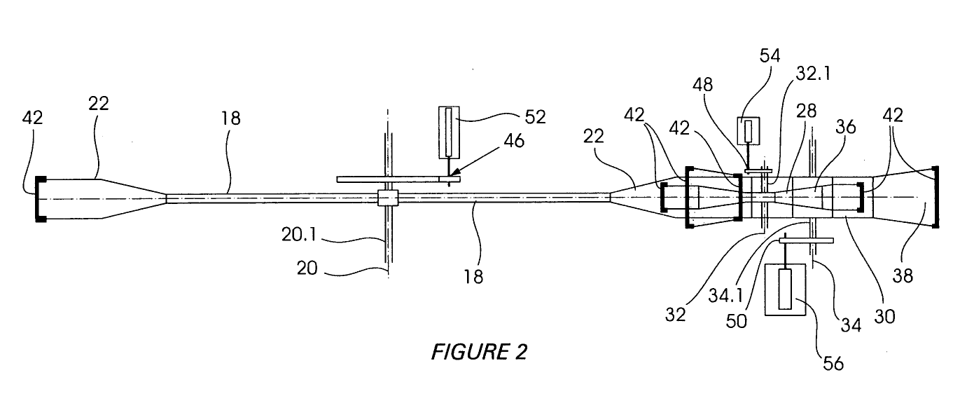

As best shown in FIG. 2, the width of the water scoops 36 of the secondary waterwheel 24 is less than the width of the water scoops 22 of the primary waterwheel 12, which in turn is less than the width of the water scoops 38 of the tertiary waterwheel 26, so as to maximize water capture. Thus, a further feature of this invention is to vary the widths of the water scoops 22, 36, 38 to ensure that as much of the falling water as possible is utilized in the system 10, so as to maximize the transfer of energy. Thus, unlike with conventional waterwheel arrangements in which most of the water driving a waterwheel is discharged whilst the waterwheel rotates, in the present invention the excess falling water is used to provide the force required to turn yet another waterwheel 24, 26 that have been placed strategically in the path of the falling water.

It should be clear from the figures that the waterwheels 12, 24, 26 are arranged sufficiently close to each other and have design features (such as the width of each water scoop) so that as much of the falling water from a higher waterwheel is captured and utilized by the waterwheel below it.

As shown in the figures, the radial arms 18, 28, 30 are tapered so that the very ends of the radial arms 18, 28, 30 (i.e. the ends of the water scoops 22, 36, 38) carry the most water so that each waterwheel 12, 24, 26 defines a flywheel to assist in the rotation of the waterwheels 12, 24, 26. In particular, each of the radial arms 18, 28, 30 of the waterwheels 12, 24, 36 is tapered out towards a weighted outer rim 42 and tapered inwards towards axles 20.1, 32.1, 34.1 that define axes 20, 32, 34, so that the entire waterwheel 12, 24, 36 takes on some of the characteristics of a flywheel as it rotates. This tapered arrangement allows for the maximum amount of water to be contained as far from the central axes 20, 32, 34 as possible, thus maximising the leverage generated from the force of the falling water.

In an example embodiment, the water scoops 22, 36, 38 of each waterwheel are connected together at their ends by the weighted outer rim 42 to create a flywheel effect.

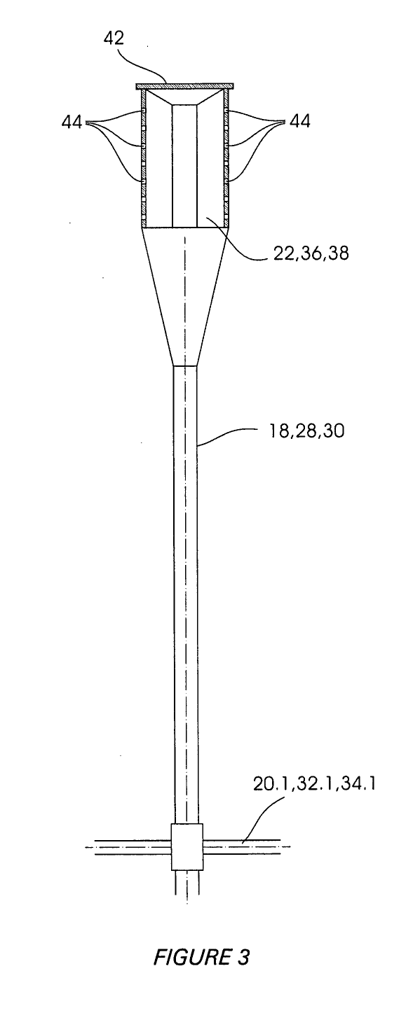

In an example embodiment, as best shown in FIG. 3, the water scoops 22, 36, 38 define breather holes 44 along their edges so as to minimize the effects of air friction.

Thus, the water scoops 22, 36, 38 are designed to increase their efficiency in the transfer of energy and decrease resistance created by stationary air. In addition, the spokes or radial arms 18, 28, 30 are wedge-shaped, so as to further reduce drag due to frictional resistance from stationary air as the waterwheels 12, 24, 36 rotate.

In an example embodiment, the waterwheels 12, 24, 36 are attached via their central axles 20.1, 32.1, 34.1 to gear mechanisms 46, 48, 50, respectively, which in turn are connected to alternator/generator systems 52, 54, 56, each capable of transferring the rotative power of each waterwheel 12, 24, 36 into electrical energy.

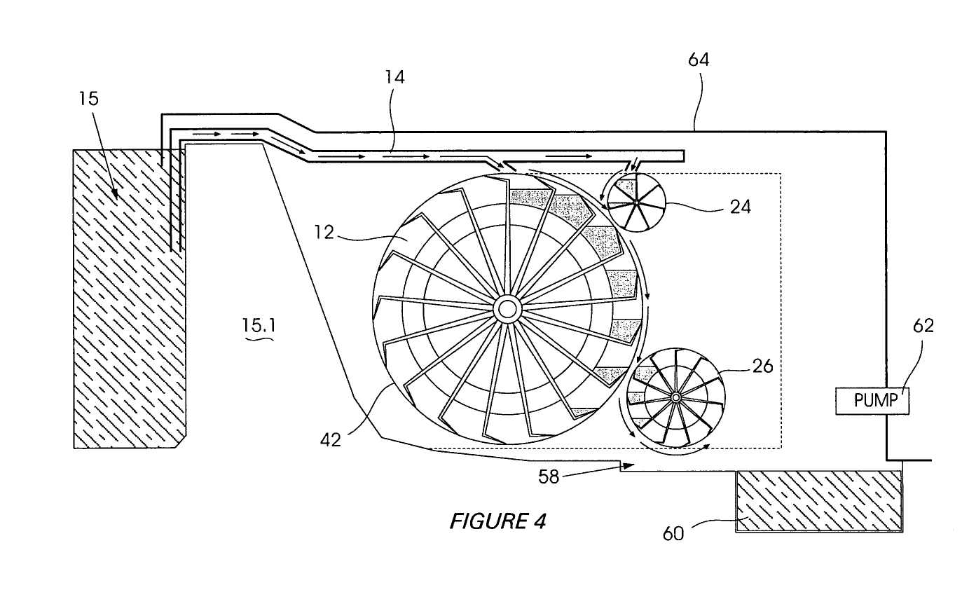

Turning to FIG. 4, in use, typical flow of water is shown from a head penstock 14 and moves sequentially through the vertically arranged waterwheels 12, 24, 36, forcing each one to rotate and thus create energy via the gearboxes 46, 48, 50 through corresponding alternator/generator systems 52, 54, 56, respectively. The arrows in FIG. 4 signify the flow direction of the falling water. Should the water finally flowing through a tailrace 58 be collected in a sump 60, rather than being allowed to simply flow away, external pumps 62 may be provided to return the water back to the head penstock 14. Alternatively, or in addition, the pumps 62 may be used to pump the water back into the dam 15 in periods of low power demand via return water pipe 64.

Although not shown, an upper pumping setup may be located in the vicinity of the head penstock so as to provide a consistent flow of water through the head penstock 14 from the dam 15 to which the head penstock 14 is fitted, even if the rest water-level within the dam 15 goes below the level of the penstock 14.

Depending on the location, the system 10 may be supported by independent structural means, partially or fully enclosed in the ground, or attached to some existing structure or natural feature.

A key advantage of the present invention is that it can be retrofitted to existing dams without extensive alterations to the dam structure, therefore not compromising the structural integrity of the existing dam.

Those skilled in the art will now see that certain modifications can be made to the apparatus and methods herein disclosed with respect to the illustrated embodiments, without departing from the spirit of the instant invention. While the invention has been described above with respect to the preferred embodiments, it will be understood that the invention is adapted to numerous rearrangements, modifications, and alterations, and all such arrangements, modifications, and alterations are intended to be within the scope of the claims included herein.

1. An energy generating system comprising:
a primary waterwheel for receiving water from a head penstock, the primary waterwheel comprising a plurality of radial arms rotatable about a primary axis, the radial arms terminating in water scoops for accommodating the water from the head penstock, the primary waterwheel defining head height; and
at least one additional waterwheel located within the head height of the primary waterwheel, the additional waterwheel also comprising a plurality of radial arms rotatable about an axis, the radial arms terminating in water scoops for accommodating either excess water from the head penstock or water that has spilled out of the water scoops of the primary waterwheel.

2. The energy generating system of claim 1, wherein the primary waterwheel and the at least one additional waterwheel are vertically oriented.

3. The energy generating system of claim 1, wherein the at least one additional waterwheel is smaller than the primary waterwheel.

4. The energy generating system of claim 1, wherein the at least one additional waterwheel comprises a secondary waterwheel for receiving excess water from the head penstock.

5. The energy generating system of claim 4, wherein the secondary waterwheel is arranged to convey water back onto the water scoops of the primary waterwheel.

6. The energy generating system of claim 1, wherein the at least one additional waterwheel comprises a tertiary waterwheel for receiving water that has spilled out of the water scoops of the primary waterwheel.

7. The energy generating system of claim 6, wherein the width of the water scoops of the secondary waterwheel is less than the width of the water scoops of the primary waterwheel, which in turn is less than the width of the water scoops of the tertiary waterwheel.

8. The energy generating system of claim 1, wherein the radial arms of each waterwheel are tapered so that the scoop situated at the very ends of the radial arms is widened so as to carry the maximum amount of water as close to the end of the radial arms as possible.

9. The energy generating system of claim 1, wherein the water scoops are connected together at their ends by a weighted outer rim to create a flywheel effect.

10. The energy generating system of claim 1, wherein the water scoops define breather holes along their edges.

11. The energy generating system of claim 1, wherein the waterwheels are attached via their central axes to a gear mechanism which is then in turn connected to an alternator/generator system, each capable of transferring the rotative power of each waterwheel into electrical energy.

12. The energy generating system of claim 1, wherein an upper pumping setup is located in the vicinity of the head penstock so as to provide a consistent flow of water through the head penstock from a dam to which the head penstock is fitted.

13. (canceled)
